(19) United States
(12) Patent Application Publication
(10) Pub. No.: US 2008/0191998 A1
(43) Pub. Date: Aug. 14, 2008

(54) LIQUID CRYSTAL DISPLAY DEVICE

(75) Inventor: Kazuyoshi KUWABATA, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 12/028,056

(22) Filed: Feb. 8, 2008

(30) Foreign Application Priority Data
Feb. 13, 2007 (JP) 2007-032268

(51) Int. Cl. G09G 3/36

(52) U.S. Cl. 345/102

(57) ABSTRACT

A liquid crystal display device includes a liquid crystal panel, a backlight, a luminance control instruction receiving component, an inverter circuit, a backlight control component and an image quality adjustment component. The liquid crystal panel displays an image. The backlight emits light to the liquid crystal panel. The luminance control instruction receiving component receives a luminance control instruction to control a luminance of the liquid crystal display device. The inverter circuit controls the light of the backlight. The backlight control component sets a backlight control amount for controlling the inverter circuit within a specific range based on the luminance control instruction when the luminance control instruction receiving component receives the luminance control instruction. The image quality adjustment component performs an image quality adjustment of the image displayed on the liquid crystal panel according to the luminance control instruction when the luminance control instruction receiving component receives the luminance control instruction.

### CROSS-REFERENCE TO RELATED APPLICATIONS

This application claims priority to Japanese Patent Application No. 2007-032268 filed on Feb. 13, 2007. The entire disclosure of Japanese Patent Application No. 2007-032268 is hereby incorporated herein by reference.

### BACKGROUND OF THE INVENTION

1. Field of the Invention

The present invention generally relates to a liquid crystal display device. More specifically, the present invention relates to a liquid crystal display device having a backlight.

2. Background Information

Liquid crystal display devices have become very popular today as devices for displaying images in television sets and other image processing devices. Liquid crystal display devices have advantages over conventional CRT-type display devices in that the liquid crystal display devices are smaller and have lower power consumption. Therefore, the liquid crystal display devices are widely used not only in television sets, but also in notebook personal computers, car navigation systems, and various other electronic devices.

A conventional liquid crystal display device includes a backlight, a backlit liquid crystal display panel and an inverter circuit. The backlight is provided to a back of the backlit liquid crystal display panel. The backlight is lit so that users can view an image on the backlit liquid crystal display panel. The light from the backlight is controlled by the inverter circuit. Specifically, light control is performed by PWM (pulse width modulation) control. The PWM control changes an on/off switching time of an inverter transformer of the inverter circuit by means of a light control pulse.

However, the above-mentioned light control method in which the inverter circuit is used has a number of problems. First, frequently switching the inverter transformer on and off generates extra heat at a start-up of the inverter transformer. As a result, thermal efficiency is poor, and this adversely affects designing of suitable thermal efficiency.

In addition, depending on specifications of the inverter transformer, the inverter may make noise or the transformer may hum. Thus, some means for dealing with the problems has to be provided in the device. Furthermore, the backlight consumes more power than other components of the liquid crystal display device. Thus, the liquid crystal display device has to be designed while taking power consumption of the backlight into account. Specifically, the liquid crystal display device has to be designed so as to ensure the lowest possible operating voltage for the liquid crystal display device as a whole. This tends to drive up the cost of development.

With a conventional liquid crystal display device, when luminance is decreased by light control of a backlight in the liquid crystal display device, a decrease in apparent contrast is compensated (see Japanese Laid-Open Patent Application 2000-148072, for example). Thus, a decrease in display quality is reduced.

With the conventional liquid crystal display device, display luminance is increased for a region of high display luminance in a halftone region of a display image so that contrast in the halftone region of the display image increases as the luminance of the backlight is decreased by adjusting a backlight luminance. At the same time, a gain is adjusted for a display drive signal with respect to an input image signal so as to lower the display luminance of a region of low display luminance.

With the conventional liquid crystal display device, even when the luminance is changed by raising or lowering (changing) the luminance of the backlight, there is little change in the apparent contrast of the display image. As a result, the decrease in display quality is suppressed. Therefore, an allowable range of control over backlight luminance is expanded. Furthermore, light control noise caused by synchronization deviation is reduced by synchronizing periods of the light control pulse with the image signal.

With the conventional liquid crystal display device, luminance adjustment for preventing the decrease in contrast is performed when the luminance of the backlight is lowered. However, in the luminance adjustment, the conventional PWM control is used. Consequently, the same problems are encountered as mentioned above (such as the transformer hum or the inverter noise during light control). Thus, some separate means has to be provided for the problems.

In view of the above, it will be apparent to those skilled in the art from this disclosure that there exists a need for an improved receiving apparatus. This invention addresses this need in the art as well as other needs, which will become apparent to those skilled in the art from this disclosure.

### SUMMARY OF THE INVENTION

The present invention is conceived in light of the above problems. One object of the present invention is to provide a liquid crystal display device with which a light control of a backlight is appropriately performed.

In accordance with one aspect of the present invention, a liquid crystal display device includes a liquid crystal panel, a backlight, a luminance control instruction receiving component, an inverter circuit, a backlight control component and an image quality adjustment component. The liquid crystal panel is configured to display an image. The backlight is configured to emit light to the liquid crystal panel. The luminance control instruction receiving component is configured to receive a luminance control instruction to control a luminance of the liquid crystal display device. The inverter circuit is configured to control the light of the backlight. The backlight control component is configured to set a backlight control amount for controlling the inverter circuit within a specific range based on the luminance control instruction when the luminance control instruction receiving component receives the luminance control instruction. The image quality adjustment component is configured to perform an image quality adjustment of the image displayed on the liquid crystal panel according to the luminance control instruction when the luminance control instruction receiving component receives the luminance control instruction.

With the liquid crystal display device of the present invention, it is possible to provide a liquid crystal display device with which a light control of a backlight is appropriately performed.

These and other objects, features, aspects and advantages of the present invention will become apparent to those skilled in the art from the following detailed description, which, taken in conjunction with the annexed drawings, discloses selected embodiments of the present invention.

### BRIEF DESCRIPTION OF THE DRAWINGS

Referring now to the attached drawings which form a part of this original disclosure:

FIG. 1 is a block diagram of a liquid crystal display device in accordance with the first embodiment of the present invention;

FIG. 2 is a block diagram illustrating a functional configuration of a microcomputer of the liquid crystal display device illustrated in FIG. 1;

FIG. 3 is a flowchart illustrating an operation of the liquid crystal display device illustrated in FIG. 1;

FIG. 4 is a diagram of an example of an image quality adjustment instruction in accordance with the first embodiment the present invention;

FIG. 5 is a flowchart illustrating an operation of a liquid crystal display device in accordance with a second embodiment of the present invention; and

FIG. 6 is a diagram of an example of an image quality adjustment instruction in accordance with the second embodiment of the present invention.

### DETAILED DESCRIPTION OF THE PREFERRED EMBODIMENTS

Selected embodiments of the present invention will now be explained with reference to the drawings. It will be apparent to those skilled in the art from these disclosures that the following descriptions of the selected embodiments of the present invention are provided for illustration only and not for the purpose of limiting the invention as defined by the appended claims and their equivalents.

### First Embodiment

### 1-1. Internal Configuration of Liquid Crystal Display Device

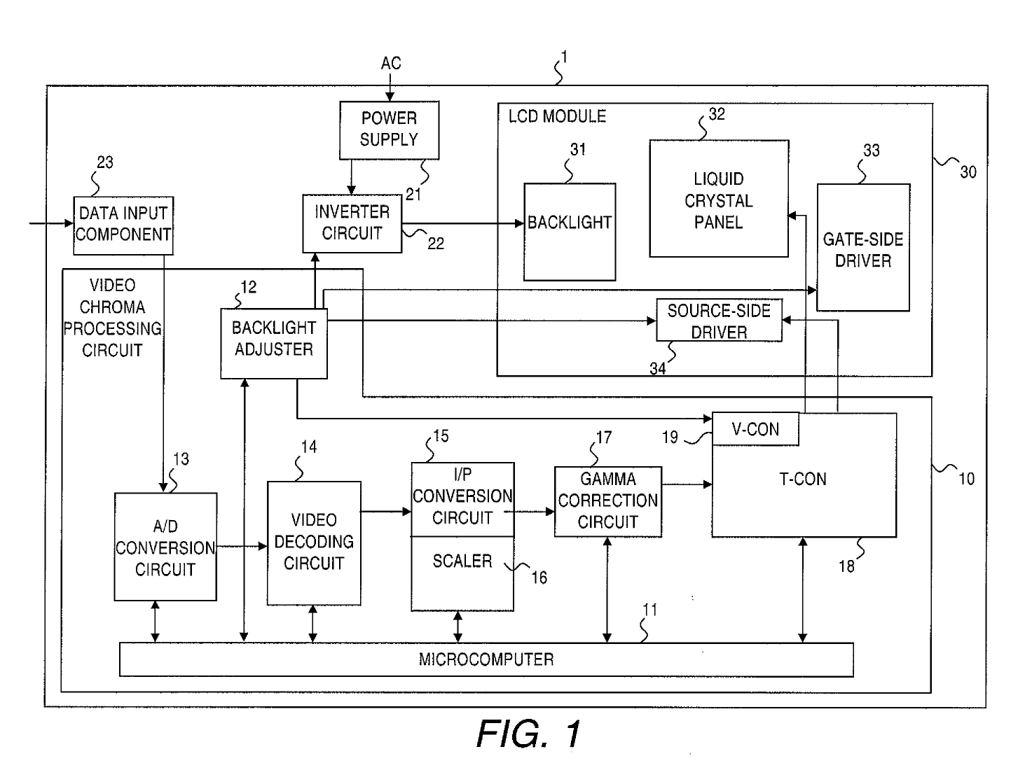

FIG. 1 is a block diagram of a liquid crystal television 1 (e.g., liquid crystal display device). The liquid crystal television 1 includes a video chroma processing circuit 10, a power supply 21, an inverter circuit 22, a data input component 23 and an LCD module 30.

The video chroma processing circuit 10 includes a microcomputer 11, a backlight adjuster (e.g., backlight adjustment component) 12, an A/D conversion circuit 13, a video decoding circuit 14, an I/P conversion circuit 15, a scaler 16, a gamma correction circuit 17, a T-CON (Timing Converter) 18 and a V-CON (Video Converter) 19. The LCD module 30 includes a backlight 31, a liquid crystal panel 32, a gate-side driver 33 and a source-side driver 34.

The video chroma processing circuit 10 receives an image signal from the data input component 23, and performs various kinds of image processing (e.g., image quality adjustment) based on various synchronization signals, such as a horizontal synchronization signal or a vertical synchronization signal. Each components of the video chroma processing circuit 10 are controlled by the microcomputer 11. The microcomputer 11 includes a plurality of microprocessors, and handles overall controls of the image processing, such as displaying inputted image information and adjusting image quality. Each functional components of the microcomputer 11 will be described in detail below.

The backlight adjuster 12 controls the gate-side driver 33 and the source-side driver 34 of the LCD module 30 based on the various synchronization signals extracted from the signals inputted by the data input component 23. The backlight adjuster 12 also controls the inverter circuit 22. For example, the backlight adjuster 12 produces a light control pulse for adjusting an amount of light emitted by the backlight 31. The light control pulse is sent through the inverter circuit 22 to the backlight 31. As a result, the light of the backlight 31 is controlled.

The AID conversion circuit 13 inputs an analog image signal, such as a composite video signal or an S signal, from the data input component 23. Then, the A/D conversion circuit 13 converts the inputted analog image signal into a digital signal. The digital signal obtained by the conversion is further converted by the video decoding circuit 14 into image data. Then, the image data is subjected to various kinds of image quality adjustment, such as an adjustment of contrast, an adjustment of brightness, an adjustment of black stretching and an adjustment of gamma correction.

Then, if necessary, conversion between an interlace system and a progressive system is performed by the I/P (interlace/progressive) conversion circuit 15, or resolution adjustment is performed by the scaler 16. After the gamma correction is performed by the gamma correction circuit 17, the image data is sent as an RGB signal by the T-CON 18 to the LCD module 30.

The power supply 21 receives AC power from outside and converts the AC power to DC voltage. Then, the power supply 21 supplies the DC voltage to each of the components of the liquid crystal television 1. The inverter circuit 22 performs light control of the backlight 31 based on the light control pulse sent from the backlight adjuster 12. More specifically, PWM control is performed, which changes an on/off switching time of an inverter transformer of the inverter circuit 22 by means of the light control pulse. The light control of the backlight 31 is performed since an amount of light emitted by the backlight 31 varies along with a ratio of the on and off times.

The data input component 23 is an input interface for inputting various signals, such as image signals, from a digital tuner or another external device. The inputted image signal is sent to the video chroma processing circuit 10 and subjected to various processing. Then, the inputted image signal is displayed on the LCD module 30. More specifically, the data input component 23 includes a plurality of input terminals, such as S signal input terminals for inputting S signals, or RCA jacks for inputting composite video signals.

The backlight 31 is a light emitting device disposed on back side of the liquid crystal panel 32. The backlight 31 makes use of an edge-lit system in which a cold cathode tube is used as the light source, or a directly back-lit system in which a fluorescent lamp is disposed on a back face of the liquid crystal panel 32. The amount of light emitted by the light source of the backlight 31 is adjusted by the backlight adjuster 12 and the inverter circuit 22.

The gate-side driver 33 and the source-side driver 34 produce voltage that is applied to each pixels of the liquid crystal panel 32 based on the RGB signals forming the image, and the various synchronization signals sent from the video chroma processing circuit 10. The liquid crystal panel 32 displays the image on a panel face by changing transmissivity of the liquid crystal panel 32 based on the applied voltage.

### 1-2. Configuration of Functional Components of Liquid Crystal Display Device

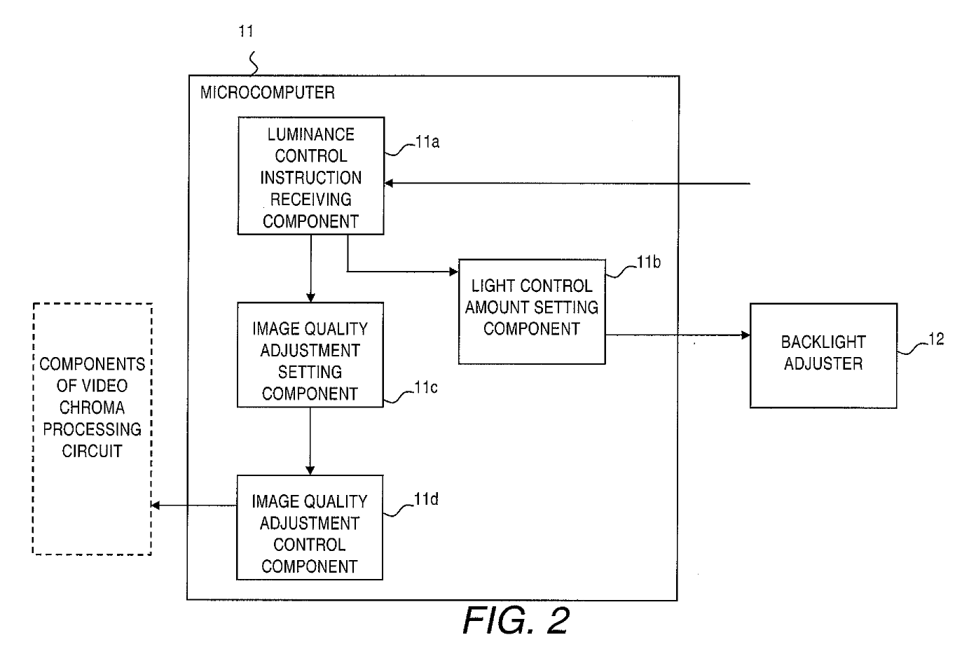

As shown in FIG. 2, luminance control processing of the liquid crystal television 1 is mainly carried out by the microcomputer 11 and the backlight adjuster 12. The microcomputer 11 includes a luminance control instruction receiving component 11a, a light control amount setting component 11b, an image quality adjustment setting component 11c and an image quality adjustment control component 11d.

The luminance control instruction receiving component 11a receives a luminance control instruction from the user. The luminance control instruction is an instruction for the microcomputer 11 to carry out the luminance control processing. The luminance control instruction is inputted via input component (not shown) of the liquid crystal television 1, such as a remote or a control button group disposed on the liquid crystal television 1. The luminance control instruction includes luminance information indicating levels of the luminance (brightness) of the liquid crystal panel 32. The user uses the control button group to input the luminance control instruction to set a level of the luminance for the liquid crystal panel 32. The luminance is set by choosing from three levels of “bright,” “normal,” and “dark,” or by setting an adjustment value that has been broken down into several dozen levels of the luminance.

The light control amount setting component 11b sets a backlight control amount for performing the light control of the backlight 31 by the backlight adjuster 12 and the inverter circuit 22 based on the luminance control instruction when the luminance control instruction receiving component 11a has received the luminance control instruction. The backlight adjuster 12 controls the on/off switching of the inverter circuit 22 by the PWM control based on the backlight control amount that has been set. The backlight control amount set by the light control amount setting component 11b is limited to being within a specific predetermined range. The specific predetermined range is determined to be a range in which various problems of the inverter circuit 22, such as inverter noise, transformer hum, and lowered thermal efficiency, can be avoided. Therefore, the specific predetermined range for the backlight control amount set by the light control amount setting component 11b is narrower than the range used for the conventional inverter circuit.

The image quality adjustment setting component 11c sets at adjustment items of the image quality adjustment and adjustment amounts of the image quality adjustment based on the luminance control instruction when the luminance control instruction receiving component 11a has received the luminance control instruction. The adjustment items and the adjustment amounts for the image quality adjustment are outputted as an image quality adjustment instruction to the image quality adjustment control component 11d. More specifically, for example, the image quality adjustment instruction, such as to increase the contrast by three steps or decrease the brightness by two steps, is outputted to the image quality adjustment control component 11d.

The image quality adjustment control component 11d output an execution instruction (e.g., image quality adjustment execution instruction) to the various components of the video chroma processing circuit 10. The execution instruction is an instruction for executing the image quality adjustment of the image displayed on the liquid crystal panel 32. For instance, if the contrast of the image is to be adjusted, or the black stretching is to be adjusted, then the execution instruction is outputted to the video decoding circuit 14 to adjust the contrast or the black stretching. If the image is to be subjected to gamma correction, the execution instruction is outputted to the gamma correction circuit 17 to perform the gamma correction. The details of the image contrast adjustment, the brightness adjustment, the black stretching and the gamma correction can be the same as in prior art.

The image quality adjustment setting component 11c and the backlight adjuster 12 form a backlight control component configured to set a backlight control amount for controlling the inverter circuit 22 within the specific predetermined range based on the luminance control instruction when the luminance control instruction receiving component 11a receives the luminance control instruction. The image quality adjustment setting component 11c, the image quality adjustment control component 11d, the video decoding circuit 14 and the gamma correction circuit 17 form an image quality adjustment component configured to perform an image quality adjustment of the image displayed on the liquid crystal panel 32 according to the luminance control instruction when the luminance control instruction receiving component 11a receives the luminance control instruction. The video decoding circuit 14 and the gamma correction circuit 17 form an image quality adjustment execution component configured to execute the image quality adjustment based on the execution instruction.

### 1-3. Light Control of Backlight

The luminance control processing performed by the liquid crystal television 1 will be described through reference to FIGS. 1-4.

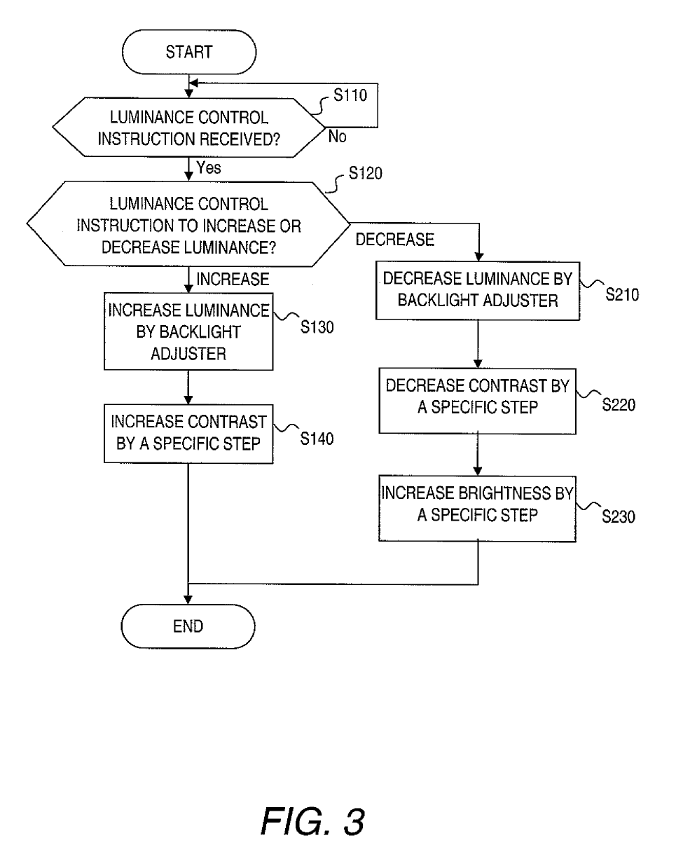

FIG. 3 is a flowchart illustrating the luminance control processing. When the luminance control processing is begun, first, the luminance control instruction receiving component 11a of the microcomputer 11 determines whether or not the luminance control instruction receiving component 11a receives the luminance control instruction for the backlight 31 (step S110).

If the luminance control instruction receiving component 11a determines that no luminance control instruction is received (step S110), then step S110 is repeated until the luminance control instruction is received. On the other hand, if the luminance control instruction is received, the luminance control instruction receiving component 11a determines whether the luminance control instruction is an instruction to increase the luminance (brighten) of the liquid crystal panel 32, or an instruction to decrease the luminance (darken) (step S120).

If the luminance control instruction receiving component 11a determines that the luminance control instruction is the instruction to increase the luminance (step S120), the luminance control instruction receiving component 11a notifies the light control amount setting component 11b and the image quality adjustment setting component 11c that the instruction is to increase the luminance. Upon receiving the notification, the light control amount setting component 11b outputs the backlight control instruction to the backlight adjuster 12 (step S130). The backlight control amount of the backlight control instruction is limited to the specific predetermined range, such as a range in which the inverter noise generated by the inverter circuit 22 will not affect other devices disposed around the inverter circuit 22. Specifically, fluctuation of an oscillation frequency in the PWM control for the inverter circuit 22 is kept within a narrow range so that the inverter noise does not affect other devices. Upon receiving the backlight control instruction, the backlight adjuster 12 controls the inverter circuit 22 and increases the amount of light emitted by the backlight 31 with in the specific predetermined range.

Also, upon receiving the notification that the instruction is to increase the luminance, the image quality adjustment setting component 11c outputs the image quality adjustment instruction for the image displayed on the liquid crystal panel 32 to the image quality adjustment control component 11d (step S140). Upon receiving the image quality adjustment instruction, the image quality adjustment control component 11d outputs the execution instruction to increase the contrast of the image by a specific value to the video decoding circuit 14.

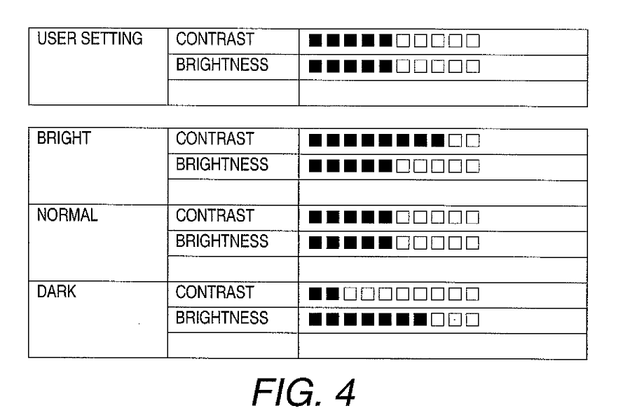

FIG. 4 is a diagram of an example of the image quality adjustment instruction. The uppermost level shows an default setting set by the user. The lower three levels show the image quality adjustment instructions corresponding to the luminance control instruction. In FIG. 4, a black square is a valid value, and a white square is an invalid value.

If the luminance of the backlight 31 is set to “normal” by the user when the contrast value set ahead of time by the user is “5” and the brightness value is “5”, then the contrast and brightness values are left unchanged and set to the values “5”.

In contrast, if the image quality adjustment instruction is outputted by the image quality adjustment setting component 11c (step S140), then the image quality adjustment is performed. Specifically, if the luminance of the backlight 31 is set to “bright” by the user when the contrast value set ahead of time by the user is “5” and the brightness value is “5”, then “3” (a specific value) is added to the contrast value so that the contrast value is set to “8” and the brightness value is set to “5”, as indicated by the “bright” row as shown in FIG. 4. The image quality adjustment is executed internally, and is preferably imperceptible to the user.

Conversely, if the luminance control instruction receiving component 11a determines that the luminance control instruction is the instruction to decrease the luminance (step S120), the luminance control instruction receiving component 11a notifies the light control amount setting component 11b and the image quality adjustment setting component 11c that the instruction is to decrease the luminance. Upon receiving the notification, the light control amount setting component 11b outputs the backlight control instruction to the backlight adjuster 12 (step S210). The backlight control amount of the backlight control instruction is limited to the specific predetermined range, just as in step S130. Upon receiving the backlight control instruction, the backlight adjuster 12 controls the inverter circuit 22 and reduces the amount of light emitted by the backlight 31.

Also, upon receiving the notification that the instruction is to decrease the luminance, the image quality adjustment setting component 11c outputs a contrast adjustment instruction as the image quality adjustment instruction to the image quality adjustment control component 11d (step S220). Upon receiving the contrast adjustment instruction, the image quality adjustment control component 11d outputs the execution instruction to the video decoding circuit 14 to decrease the contrast of the image by a specific value.

Also, the image quality adjustment setting component 11c outputs a brightness adjustment instruction as the image quality adjustment instruction to the image quality adjustment control component 11d (step S230). Upon receiving the brightness adjustment instruction, the image quality adjustment control component 11d outputs the execution instruction to the video decoding circuit 14 to increase the brightness of the image by a specific value. Then, the processing is concluded.

As shown in FIG. 4, if the luminance of the backlight 31 is set to “normal” by the user when the contrast value set ahead of time by the user is “5” and the brightness value is “5”, then the contrast and brightness values are left unchanged and set to the values “5”.

In contrast, if the image quality adjustment instruction (the contrast adjustment instruction and the brightness adjustment instruction) is outputted by the image quality adjustment setting component 11c (steps S220 and S230), then an adjustment is performed. Specifically, if the luminance of the backlight 31 is set to “dark” by the user when the contrast value set ahead of time by the user is “5” and the brightness value is “5”, then “3” (a specific value) is subtracted from the contrast value and “2” (a specific value) is added to the brightness value so that the contrast value is set to “2” and the brightness value is set to “7”, as indicated by the “dark” row as shown in FIG. 4. The image quality adjustment is executed internally, and is preferably imperceptible to the user.

With the liquid crystal television 1, the image is displayed by the liquid crystal panel 32 equipped with the backlight 31 on the back face. The luminance of the liquid crystal panel 32 is adjusted by using PWM control or the like. Specifically, the luminance of the liquid crystal panel 32 is adjusted by varying the power applied to the inverter transformer provided to the inverter circuit 22. The inverter circuit 22 is controlled by the backlight adjuster 12. The image quality adjustment control component 11d outputs the execution instruction to adjust the image quality of the image displayed on the liquid crystal panel 32. The image quality adjustment includes items, such as the brightness (luminance) adjustment or the contrast adjustment (the luminance ratio between the brightest and darkest portions of the liquid crystal panel 32). The video decoding circuit 14 executes the image quality adjustment when the video decoding circuit receives the execution instruction. When the luminance control instruction receiving component 11a receives the luminance control instruction from the user, the light control amount setting component 11b sets the backlight control amount of the light control to be performed by the inverter circuit 22 within the specific predetermined range according to the luminance control instruction. The backlight adjuster 12 accordingly performs control of the inverter circuit 22. The specific predetermined range indicates the range over which problems encountered with conventional light control methods involving an inverter circuit, such as inverter noise, transformer hum, and lowered thermal efficiency, can be avoided. Thus, there is a limit to the backlight amount of the light control that can be accomplished with the inverter circuit 22 used within the predetermined specific range. The image quality adjustment setting component 11c outputs the image quality adjustment instruction to the image quality adjustment control component 11d. Upon receiving the image quality adjustment instruction, the image quality adjustment control component 11d controls the video decoding circuit 14 to adjust the image quality, such as increasing or decreasing the contrast, and thereby changes the visibility of the image.

In particular, the image quality adjustment setting component 11c compensates for a lack of the light control by adjusting the visibility of the image by using the image quality adjustment control component 11d to adjust the image quality (such as the brightness or the contrast) of the image displayed on the liquid crystal panel 32. Therefore, the light control can be performed while avoiding the problems encountered in the past with the inverter circuit. More specifically, inverter noise and transformer hum can be avoided, and problems caused by fluctuation of the oscillation frequency in the PWM control, such as inadequate light emission at low temperatures, can be prevented. Also, no heat management (such as installation of a heat radiating plate) is necessary, which makes the thermal efficiency design easier and also lowers the cost of the device. Therefore, with the liquid crystal television 1, the use of a conventional light control method by PWM control, which causes the various problems listed above, is kept to a minimum. Furthermore, it is possible to provide the liquid crystal television 1 with a configuration that is simple and low in cost, with which the light control of the backlight 31 is appropriately performed.

With the liquid crystal television 1, when the luminance control instruction is received, which includes the instruction to increase the luminance of the liquid crystal panel 32, the inverter circuit 22 performs light control of the backlight 31 within the specific predetermined range. Then, the image quality adjustment setting component 11c outputs the image quality adjustment instruction to the image quality adjustment control component 11d to increase the contrast of the image by a specific value. Upon receiving the image quality adjustment instruction, the image quality adjustment control component 11d controls the video decoding circuit 14 to increase the contrast of the image, and thereby changes the visibility of the image.

In particular, when the instruction to increase the luminance of the liquid crystal panel 32 is received, the image quality adjustment setting component 11c uses the image quality adjustment control component 11d to increase the contrast of the image by a specific value. As a result, the image displayed on the liquid crystal panel 32 is balanced, and a sharp image is obtained that is easy to view. Therefore, even though the backlight control amount of light control by the inverter circuit 22 is limited, the apparent luminance of the image as seen by the eye can be increased.

With the liquid crystal television 1, when the luminance control instruction is received, which includes the instruction to decrease the luminance of the liquid crystal panel 32, the inverter circuit 22 performs light control of the backlight 31 within the specific predetermined range. Then, the image quality adjustment setting component 11c outputs the image quality adjustment instruction to the image quality adjustment control component 11d to reduce the contrast of the image by a specific value. At the same time, the image quality adjustment instruction to increase the brightness of the image by a specific value is outputted. Upon receiving the image quality adjustment instruction, the image quality adjustment control component 11d controls the video decoding circuit 14 to decrease the contrast of the image and to increase the brightness of the image, and thereby changes the visibility of the image.

In particular, when the instruction to decrease the luminance of the liquid crystal panel is received, the image quality adjustment setting component 11c uses the image quality adjustment control component 11d to decrease the contrast of the image by a specific value. At the same time, the brightness of the image is increased by a specific value. As a result, the gradation of the image displayed on the liquid crystal panel 32 is increased. When the contrast is decreased, it appears to the user that the luminance has decreased. Therefore, even though the backlight control amount of light control by the inverter circuit 22 is limited, the apparent luminance of the image as seen by the eye can be lowered. Also, degradation in gradation caused by decreasing the contrast is suppressed by increasing the brightness.

### Second Embodiment

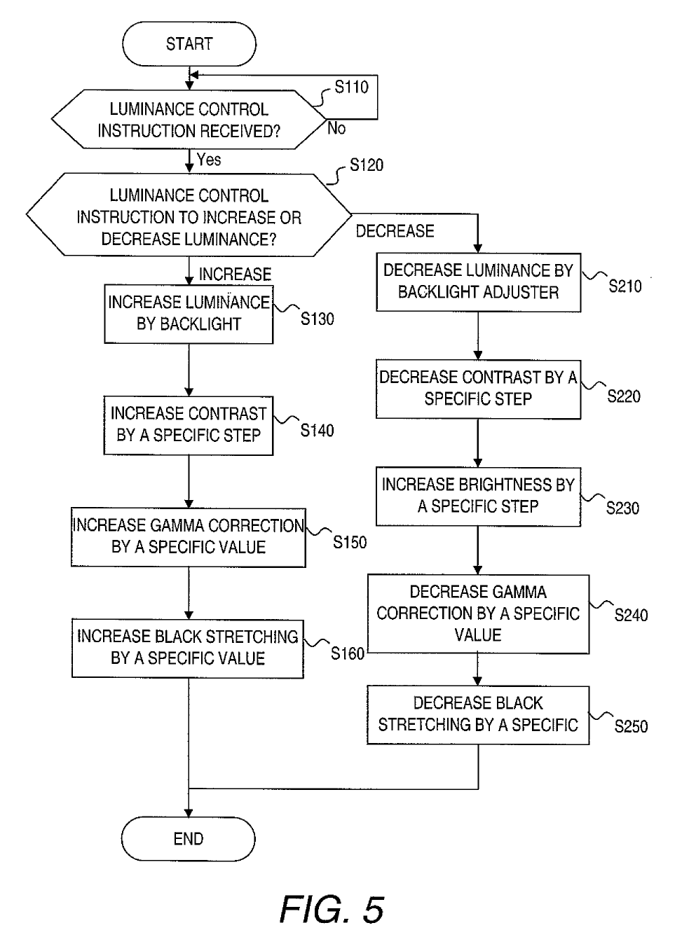

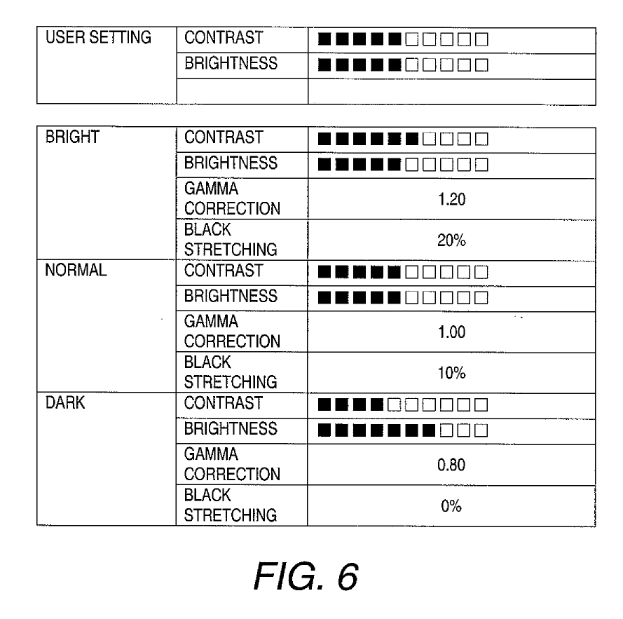

Referring now to FIGS. 5 and 6, a liquid crystal television (e.g., liquid crystal display device) in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

### 2-1. Light Control of Backlight

FIG. 5 is a flowchart illustrating a luminance control processing pertaining to the second embodiment of the present invention.

Steps S110 to S140, and steps S210 to S230 are the same as described in the first embodiment. After step S140 has been performed, the image quality adjustment setting component 11c outputs a gamma correction instruction as the image quality adjustment instruction to the image quality adjustment control component 11d (step S150). Upon receiving the gamma correction instruction, the image quality adjustment control component 11d outputs the execution instruction to the gamma correction circuit 17 to increase the gamma correction value of the image by a specific value.

Also, the image quality adjustment setting component 11c outputs a black stretching adjustment instruction as the image quality adjustment instruction to the image quality adjustment control component 11d (step S160). Upon receiving the black stretching adjustment instruction, the image quality adjustment control component 11d outputs the execution instruction to the video decoding circuit 14 to increase the degree of the black stretching of the image by a specific value. Then, the processing is concluded.

FIG. 6 is a diagram of an example of the image quality adjustment instruction. The uppermost level shows an default setting set by the user. The lower three levels show the image quality adjustment instructions corresponding to the luminance control instruction. In FIG. 6, a black square is a valid value, and a white square is an invalid value.

If the luminance of the backlight 31 is set to “normal” by the user when the contrast value set ahead of time by the user is “5” and the brightness value is “5”, then the contrast and brightness values are left unchanged and set to the values “5”. Furthermore, the gamma correction value and the black stretching value are set to “1.00” and “10%” as default values. The default values are just an example, and are not limited to these values.

In contrast, if the image quality adjustment instruction is outputted by the image quality adjustment setting component 11c (steps S140 to S160), then the image quality adjustment is performed. Specifically, if the luminance of the backlight 31 is set to “bright” by the user, then specific values are added to the values so that the contrast value is “6”, the brightness value is “5”, the gamma correction value is “1.20” , and the black stretching is “20%”, as indicated by the “bright” row in FIG. 6. The image quality adjustment is executed internally, and is preferably imperceptible to the user.

Conversely, after step S230 is performed, the image quality adjustment setting component 11c outputs the gamma correction instruction to the image quality adjustment control component 11d (step S240). Upon receiving the gamma correction instruction, the image quality adjustment control component 11d outputs the execution instruction to the gamma correction circuit 17 to reduce the gamma value of the image by a specific value.

Also, the image quality adjustment setting component 11c outputs the black stretching adjustment instruction to the image quality adjustment control component 11d (step S250). Upon receiving the black stretching adjustment instruction, the image quality adjustment control component 11d outputs the execution instruction to the video decoding circuit 14 to reduce the degree of the black stretching of the image by a specific value. Then, the processing is concluded.

As shown in FIG. 6, if the luminance of the backlight 31 is set to “normal” by the user when the contrast value set ahead of time by the user is “5” and the brightness value is “5”, then the contrast and brightness values are left unchanged and set to the values “5”.

In contrast, if the image quality adjustment instruction (the contrast adjustment instruction, the brightness adjustment instruction, the gamma correction instruction and the black stretching adjustment instruction) is outputted by the image quality adjustment setting component 11c (steps S220 to S250), then specific values are added to or subtracted from the values so that the contrast value is “4”, the brightness value is “7”, the gamma correction value is “0.80” and the black stretching is “0%”, as indicated by the “dark” row as shown in FIG. 6. The image quality adjustment is executed internally, and is preferably imperceptible to the user.

With the liquid crystal television 1, when the luminance control instruction is received, the inverter circuit 22 performs light control of the backlight within the specific predetermined range. Then, the image quality adjustment setting component 11c outputs the image quality adjustment instruction to increase or reduce the degree of black stretching to the image quality adjustment control component 11d. The black stretching is performed by the black stretching function with which the video decoding circuit 14 is equipped. The black stretching stretches relatively dark portions of the image signal further to the black side, and thereby expresses the image with a better modulated black and white balance. Upon receiving the image quality adjustment instruction, the image quality adjustment control component 11d controls the video decoding circuit 14 to adjust the black stretching of the image, and thereby changes the visibility of the image.

In particular, when the luminance control instruction is received, after the inverter circuit 22 performs light control of the backlight 31 within the specific predetermined range, any lack in the backlight control amount of light control is compensated for by changing the contrast of the image by increasing or reducing the amount of correction of the black stretching performed by a black stretching processor of the video decoding circuit 14. Therefore, finer and more effective image quality adjustment can be performed than when the contrast is merely adjusted.

With the liquid crystal television 1, when the luminance control instruction is received, the inverter circuit 22 performs light control of the backlight 31 within the specific predetermined range. Then, the image quality adjustment setting component 11c outputs the image quality adjustment instruction to the image quality adjustment control component 11d to increase or reduce the gamma correction value produced by the gamma correction circuit 17. Upon receiving the image quality adjustment instruction, the image quality adjustment control component 11d controls the gamma correction circuit 17 to adjust the gamma correction of the image, and thereby changes the visibility of the image.

In particular, when the luminance control instruction is received, after the inverter circuit 22 performs the light control of the backlight 31 within the specific predetermined range, any lack in the backlight control amount of the light control is compensated for by increasing or reducing the gamma correction value produced by the gamma correction circuit 17. Therefore, finer and more effective image quality adjustment can be performed than when the contrast is merely adjusted.

With the liquid crystal television 1, when the luminance control instruction from the user includes the instruction to increase the luminance of the liquid crystal panel 32, the image quality adjustment setting component 11c outputs the image quality adjustment instruction to increase by a specific value the gamma correction value, the black stretching value, and the contrast of the image to the image quality adjustment control component 11d. Conversely, when the luminance control instruction includes the instruction to decrease the luminance of the liquid crystal panel, the image quality adjustment setting component 11c outputs the image quality adjustment instruction to reduce by a specific value the gamma correction value, the black stretching value, and the contrast of the image and the image quality adjustment instruction to increase by a specific value the brightness of the image. Upon receiving the image quality adjustment instructions, the image quality adjustment control component 11d adjusts the image quality by controlling the video decoding circuit 14 and the gamma correction circuit 17.

### Other Embodiments

The present invention is not necessarily limited to the above embodiments, and various modifications are possible within the scope of its technological concept.

In the above embodiments, when the backlight control instruction is received, the light control performed by the inverter transformer of the inverter circuit 22 is kept to a minimum within the specific predetermined range. The width of the specific predetermined range can be varied freely, as long as the specific predetermined range causes no problems as the conventional light control methods, such as excessive inverter noise or transformer hum. Also, when the backlight control amount set based on the luminance control instruction is small, the light control can be performed only by the image quality adjustment without performing the light control by the inverter transformer.

The functional components of the microcomputer 11 can be realized by executing a program on the microcomputer 11 or other such computational processing device, or by a plurality of circuits.

In the above embodiments, the liquid crystal television 1 is described as an example of the liquid crystal display device of the present invention for the light control of the backlight 31. However, the same effect can also be obtained by using the luminance control processing of the present invention in an electronic device equipped with another kind of display device. For instance, the liquid crystal display device can be a notebook personal computer, a camera with a monitor, a car navigation system, or the like.

In the above embodiments, the user selects the luminance (brightness) of the backlight 31 from among three levels of “bright,” “normal,” and “dark,”. However, the luminance can be selected by using other levels. For instance, the liquid crystal television 1 can be readied with 10 levels from “level 1 (brightest)” to “level 10 (darkest),” and the contrast, the brightness, the gamma correction, the black stretching, and so forth can be adjusted according to the levels.

In the above embodiments, when “bright” is selected by the luminance control instruction, the contrast value, the gamma correction value and the black stretching value are increased. However, only some of the values can be increased, and some can be reduced, so that the apparent luminance by the eye is increased as a whole. For example, it is possible to increase the contrast value by large amount and decrease the gamma correction value and the black stretching value by small amount, respectively, so that the apparent luminance is increased as a whole. The same applies when “dark” is selected by luminance control instruction.

In the above embodiments, the detection of the luminance control instruction produced by user operation is given as an example of a trigger for commencing the luminance control processing. However, something else can be used as the trigger to perform the luminance control processing. For example, the luminance control processing can be carried out as an automatic light control function that is performed by detecting a change in the luminance around the liquid crystal television 1 with a dimmer sensor.

In the above embodiments, the adjustment amount of the image quality adjustment (contrast, etc.) is increased or decreased according to a change in the luminance of the backlight 31 (such as “bright,” “dark” or “normal”) designed by the user. However, the adjustment amount of the image quality adjustment can be increased or decreased internally according to a preset luminance when the user performs the image quality adjustment. More specifically, when the user increases the contrast value by “1” using an image quality adjustment function, the contrast value is internally increased by “1” when the luminance is set to “normal,” the contrast value is internally increased by “0.5” when the luminance is set to “dark,” and the contrast value is internally increased by “1.5” when the luminance is set to “bright.” As a result, even though the user intended to set the same contrast value, a different contrast value corresponding to brightness is internally set by internal processing. Therefore, correction of the luminance control processing can be performed by the backlight adjuster 12.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from these disclosure that various changes and modifications can be made herein without departing from the scope of the invention as defined in the appended claims. Furthermore, the foregoing descriptions of the selected embodiments according to the present invention are provided for illustration only, and not for the purpose of limiting the invention as defined by the appended claims and their equivalents.

What is claimed is:

1. A liquid crystal display device comprising:
a liquid crystal panel configured to display an image;
a backlight configured to emit light to the liquid crystal panel;
a luminance control instruction receiving component configured to receive a luminance control instruction to control a luminance of the liquid crystal display device;
an inverter circuit configured to control the light of the backlight;
a backlight control component configured to set a backlight control amount for controlling the inverter circuit within a specific range based on the luminance control instruction when the luminance control instruction receiving component receives the luminance control instruction; and
an image quality adjustment component configured to perform an image quality adjustment of the image displayed on the liquid crystal panel according to the luminance control instruction when the luminance control instruction receiving component receives the luminance control instruction.

2. The liquid crystal display device according to claim 1, wherein the image quality adjustment component includes
an image quality adjustment setting component being configured to set an adjustment item of the image quality adjustment and an adjustment amount of the image quality adjustment based on the luminance control instruction, and output an image quality adjustment instruction including the adjustment item and the adjustment amount,
an image quality adjustment control component being configured to control the image quality adjustment based on the image quality adjustment instruction, and output an image quality adjustment execution instruction based on the image quality adjustment instruction, and
an image quality adjustment execution component being configured to execute the image quality adjustment based on the image quality adjustment execution instruction.

3. The liquid crystal display device according to claim 2, wherein
the backlight control component includes
a light control amount setting component being configured to set the backlight control amount based on the luminance control instruction, and output the backlight control amount, and
a backlight adjustment component being configured to control the inverter circuit based on the backlight control amount

4. The liquid crystal display device according to claim 3, wherein
the image quality adjustment setting component is configured to output the image quality adjustment instruction to increase contrast of the image by a specific value when the luminance control instruction receiving component receives the luminance control instruction to increase the luminance of the liquid crystal display device.

5. The liquid crystal display device according to claim 3, wherein
the image quality adjustment setting component is configured to output the image quality adjustment instruction to decrease contrast of the image by a specific value and to increase brightness of the image by a specific value when the luminance control instruction receiving component receives the luminance control instruction to decrease the luminance of the liquid crystal display device.

6. The liquid crystal display device according to claim 3, wherein
the image quality adjustment setting component is configured to output the image quality adjustment instruction to increase or decrease a black stretching value of the image by a specific value when the luminance control instruction receiving component receives the luminance control instruction to change the luminance of the liquid crystal display device.

7. The liquid crystal display device according to claim 3, wherein
the image quality adjustment execution component includes a gamma correction circuit,
the image quality adjustment setting component is configured to output the image quality adjustment instruction to increase or decrease a gamma correction value of the image by a specific value when the luminance control instruction receiving component receives the luminance control instruction to change the luminance of the liquid crystal display device, and
the image quality adjustment control component is configured to control the gamma correction circuit based on the image quality adjustment instruction.

8. The liquid crystal display device according to claim 4, wherein
the image quality adjustment setting component is configured to output the image quality adjustment instruction to decrease the contrast of the image by a specific value and to increase brightness of the image by a specific value when the luminance control instruction receiving component receives the luminance control instruction to decrease the luminance of the liquid crystal display device.

9. The liquid crystal display device according to claim 8, wherein
the image quality adjustment setting component is configured to output the image quality adjustment instruction to increase or decrease a black stretching value of the image by a specific value when the luminance control instruction receiving component receives the luminance control instruction to change the luminance of the liquid crystal display device.

10. The liquid crystal display device according to claim 9, wherein
the image quality adjustment execution component includes a gamma correction circuit,
the image quality adjustment setting component is configured to output the image quality adjustment instruction to increase or decrease a gamma correction value of the image by a specific value when the luminance control instruction receiving component receives the luminance control instruction to change the luminance of the liquid crystal display device, and
the image quality adjustment control component is configured to control the gamma correction circuit based on the image quality adjustment instruction.

11. The liquid crystal display device according to claim 8, wherein
the image quality adjustment setting component is configured to output the image quality adjustment instruction to increase a black stretching value of the image by a specific value and to increase a gamma correction value of the image by a specific value when the luminance control instruction receiving component receives the luminance control instruction to increase the luminance of the liquid crystal display device, and is configured to output the image quality adjustment instruction to decrease the black stretching value of the image by a specific value and to decrease the gamma correction value of the image by a specific value when the luminance control instruction receiving component receives the luminance control instruction to decrease the luminance of the liquid crystal display device.

12. The liquid crystal display device according to claim 11, wherein
the image quality adjustment execution component includes a video decoding circuit and a gamma correction circuit, and
the image quality adjustment control component is configured to control the video decoding circuit and the gamma correction circuit based on the image quality adjustment instruction.

13. A control method for a liquid crystal display device, comprising:
receiving a luminance control instruction to control a luminance of the liquid crystal display device;
setting a backlight control amount for controlling an inverter circuit within a specific range to control light of a backlight of the liquid crystal display device based on the luminance control instruction upon receiving the luminance control instruction; and
performing an image quality adjustment of an image displayed on the liquid crystal display device according to the luminance control instruction upon receiving the luminance control instruction.
